(19) United States
(12) Patent Application Publication
(10) Pub. No.: US 2019/0057415 A1
(43) Pub. Date: Feb. 21, 2019

(54) SYSTEMS AND METHODS FOR PROVIDING CONTENT ITEM COLLECTIONS BASED ON PROBABILITY OF SPENDING TIME ON RELATED CONTENT ITEMS IN A SOCIAL NETWORKING SYSTEM

(71) Applicant: Facebook, Inc., Menlo Park, CA (US)

(72) Inventor: Taylor Gordon, New York, NY (US)

(21) Appl. No.: 15/682,409

(22) Filed: Aug. 21, 2017

(51) Int. Cl. G06Q 30/02; G06N 99/00; G06F 17/18

(52) U.S. Cl. CPC G06Q 30/0251; G06Q 30/0272; G06Q 50/01; G06F 17/18; G06N 99/005

(57) ABSTRACT

Systems, methods, and non-transitory computer readable media can obtain a plurality of content item collections, each content item collection of the plurality of content item collections including one or more content items. A score for each content item collection of the plurality of content item collections can be determined, based on a probability of a user spending time on at least one of the one or more content items included in the content item collection. The plurality of content item collections can be ranked based on respective scores. Access to at least one content item collection of the plurality of content item collections can be provided to the user based on the ranking.

### FIELD OF THE INVENTION

The present technology relates to the field of social networks. More particularly, the present technology relates to techniques for providing content items associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In some cases, content items can include media content items, such as images, videos, and audio. Content items can be presented on various surfaces, such as a profile page of a user or a feed of a user.

### SUMMARY

Various embodiments of the present disclosure can include systems, methods, and non-transitory computer readable media configured to obtain a plurality of content item collections, each content item collection of the plurality of content item collections including one or more content items. A score for each content item collection of the plurality of content item collections can be determined, based on a probability of a user spending time on at least one of the one or more content items included in the content item collection. The plurality of content item collections can be ranked based on respective scores. Access to at least one content item collection of the plurality of content item collections can be provided to the user based on the ranking.

In some embodiments, the determining the score for each content item collection of the plurality of content item collections is based on a respective probability of the user spending time on each of the one or more content items included in the content item collection.

In certain embodiments, the score for each content item collection of the plurality of content item collections includes one or more of: a sum of the respective probability of the user spending time on each of the one or more content items included in the content item collection, or an average of the respective probability of the user spending time on each of the one or more content items included in the content item collection.

In an embodiment, the providing access to at least one content item collection of the plurality of content item collections includes providing for display in a user interface at least one of: a representation of the at least one content item collection of the plurality of content item collections or a representation of a content item.

In some embodiments, content items of the at least one content item collection of the plurality of content item collections can be provided in response to selection of at least one of: the representation of the at least one content item collection of the plurality of content item collections or the representation of the content item.

In certain embodiments, the providing access to at least one content item collection of the plurality of content item collections includes providing the representation of the at least one content item collection of the plurality of content item collections for display in a content item collection tray.

In an embodiment, the one or more content items included in each content item collection of the plurality of content item collections are media content items, and the providing access to at least one content item collection of the plurality of content item collections includes providing a representation of a first content item for display in the user interface.

In some embodiments, the probability of the user spending time on the at least one of the one or more content items includes an estimated amount of time the user is likely to spend on the at least one of the one or more content items.

In certain embodiments, the probability of the user spending time on the at least one of the one or more content items included in the content item collection is determined based on a machine learning model.

In an embodiment, the machine learning model is trained to predict a probability of a user spending time on a content item included in a content item collection based on features relating to one or more of: user attributes or content item attributes.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content item collection provision module configured to provide content item collections, according to an embodiment of the present disclosure.

FIG. 2 illustrates an example collection ranking module configured to rank content item collections, according to an embodiment of the present disclosure.

FIG. 3A illustrates an example scenario for providing content item collections, according to an embodiment of the present disclosure.

FIG. 3B illustrates an example scenario for providing content item collections, according to an embodiment of the present disclosure.

FIG. 4 illustrates an example first method for providing content item collections, according to an embodiment of the present disclosure.

FIG. 5 illustrates an example second method for providing content item collections, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Content Item Collections Based on Probability of Spending Time on Related Content Items in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In some cases, content items can include media content items, such as images, videos, and audio. Content items can be presented on various surfaces, such as a profile page of a user or a feed of a user.

Conventional approaches specifically arising in the realm of computer technology can provide various types of content items to users, such as media content items. In some instances, content items can be organized as or in a collection. Conventional approaches may provide such collections to users. However, conventional approaches may not take into account a probability of users spending time on content items in a collection when providing the collection to the users. Accordingly, the content items in the collection may not be interesting or relevant to users.

An improved approach rooted in computer technology can overcome the foregoing and other disadvantages associated with conventional approaches specifically arising in the realm of computer technology. Based on computer technology, the disclosed technology can rank content item collections based on a probability of users spending time on content items included in the content item collections. For example, a probability of a user spending time can be determined for each content item included in a content item collection, and the probabilities for the content items in the content item collection can be summed or averaged in order to determine a score for the content item collection. Content item collections can be ranked according to respective scores and provided to a user. Respective scores of content item collections can be determined based on machine learning techniques. For example, a machine learning model can be trained to determine a probability of a user spending time on a content item of a content item collection. In this manner, content item collections that are provided to users can include content items that the users are likely to spend time on and find interesting or relevant. Additional details relating to the disclosed technology are provided below.

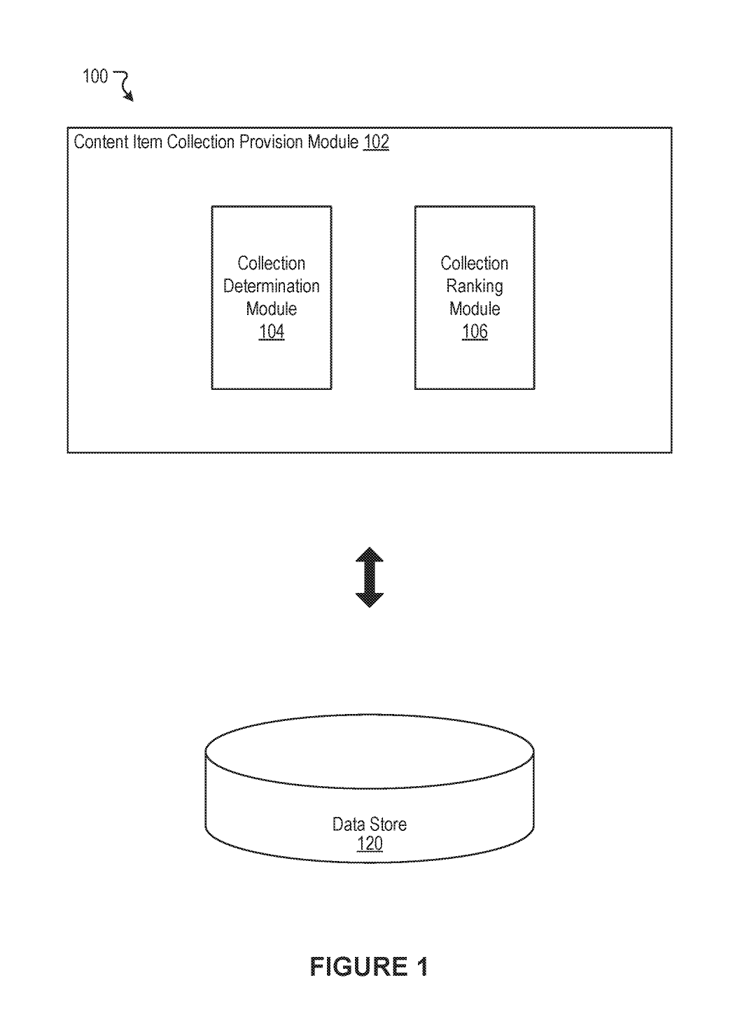

FIG. 1 illustrates an example system 100 including an example content item collection provision module 102 configured to provide content item collections, according to an embodiment of the present disclosure. The content item collection provision module 102 can include a collection determination module 104 and a collection ranking module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the content item collection provision module 102 can be implemented in any suitable combinations. While the disclosed technology is described in connection with content item collections and related content items associated with a social networking system for illustrative purposes, the disclosed technology can apply to any other type of system and/or content.

The collection determination module 104 can determine or define content item collections. One or more content items provided in a social networking system can be organized as or in a content item collection. Content items may be created by users of the social networking system. Users of the social networking system can include individual users, organizations, etc. Content items can include various types of content. For example, content items can include media content items, such as images, videos, audios, etc. There can be different types of content item collections. In some embodiments, a content item collection can be user-based. A user-based content item collection can be associated with a specific user and include one or more content items created by the specific user. In other embodiments, a content item collection can be topic-based. A topic-based content item collection is not associated with a specific user, but rather with a topic or a subject matter. For example, a topic-based content item collection relating to a theme can include content items from different users that relate to the theme. In some embodiments, a content item collection can be predefined or predetermined. For example, a user-based content item collection is associated with content items of a specific user and can be predetermined in the sense that the content item collection includes content items of the specific user. In other embodiments, a content item collection can be determined dynamically, for example, in response to an action or a request. For example, a topic-based content item collection can be generated dynamically in response to a search and can include one or more content items related to the search. In some embodiments, content item collections and/or content items can be ephemeral and may expire after a time period.

A content item collection can be provided (or presented, displayed, etc.) to a user in various ways. In some embodiments, a representation of a content item collection is provided to a user in a user interface. When the user selects the representation of the content item collection, content items included in the content item collection can be provided to the user. The content items can be provided in the same user interface or a second user interface. In other embodiments, a representation of a first content item in a content item collection can be provided to a user in a user interface. When the user selects the representation of the first content item, the first content item and other content items in the content item collection can be provided to the user. The first content item and the other content items can be provided in the same user interface or a second user interface. As an example, if the content items in the content item collection are videos relating to a topic, a representation (e.g., a thumbnail) of the first video in the content item collection can be provided in the user interface. When the user selects the representation of the first video, playback of the first video can be initiated, and other videos in the content item collection can be provided as related videos of the first video. Examples of a representation of a content item collection or a content item can include an avatar of a user, an icon, an image, an animation, a video, etc. Many variations are possible. A user may select a representation of a content item collection or a content item by a click, a touch gesture, etc. In certain embodiments, a second user interface for providing content items in a content item collection can be an immersive viewer.

In some embodiments, a content item collection can be associated with a particular content item. For example, the particular content item can have a content item collection that includes related content items of the particular content item. In these embodiments, a representation of the particular content item can be provided to a user in a user interface, and when the user selects the representation, content items in the content item collection can be provided to the user. The content items in the content item collection can be provided to the user in the same user interface or a second user interface. As an example, if the particular content item is a video, the content item collection associated with the particular content item can include videos related to the particular content item. A thumbnail of the particular content item can be provided in the user interface, and when the user selects the thumbnail, playback of the particular content item can be initiated, and related videos in the content item collection can be provided.

A content item collection can be provided to a user on various surfaces. A surface can indicate any user interface or any portion of a user interface through which a content item collection can be provided. As used herein, provision of a content item or content item collection can include, for example, presentation or display of the content item or the content item collection on a computing device or provision of the content item or the content item collection to a computing device for presentation or display on the computing device. In some embodiments, a surface can be determined or defined based on one or more of the following: a website, a webpage, a particular section of a webpage, an application, a particular page of an application, a particular section of a page of an application, an operating system (OS), a platform (e.g., mobile, desktop, etc.), a type of device, etc. In connection with a social networking system, examples of surfaces can include a feed of a user, a search, a timeline of a page, a profile of a user, a content item collection tray, an immersive viewer, etc. Many variations are possible. All examples herein are provided for illustrative purposes, and there can be many variations and other possibilities.

The collection ranking module 106 can rank content item collections. Content item collections can be ranked based on a probability of a user spending time on content items in a content item collection. Content item collections can be ranked based on machine learning techniques. For example, a machine learning model can be trained to determine a probability of users spending time on content items. Functionality of the collection ranking module 106 is described in more detail herein.

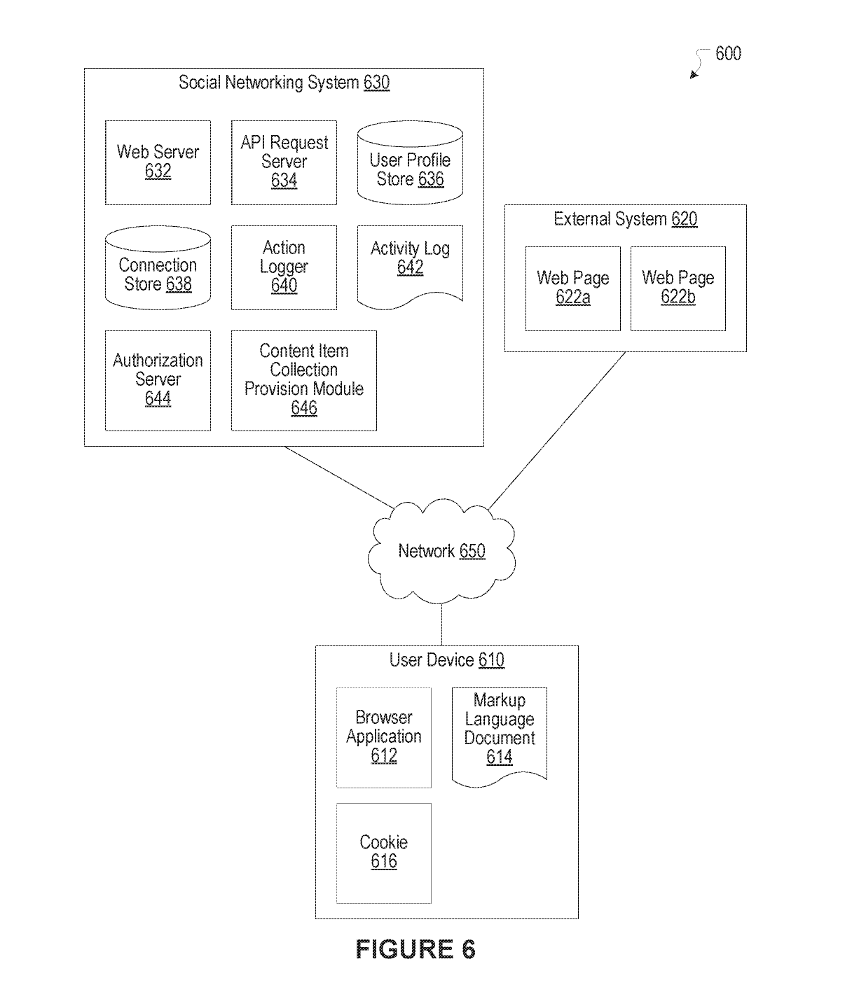

In some embodiments, the content item collection provision module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content item collection provision module 102 can be, in part or in whole, implemented as software running on one or more computing devices or systems, such as on a server system or a client computing device. In some instances, the content item collection provision module 102 can be, in part or in whole, implemented within or configured to operate in conjunction or be integrated with a social networking system (or service), such as a social networking system 630 of FIG. 6. Likewise, in some instances, the content item collection provision module 102 can be, in part or in whole, implemented within or configured to operate in conjunction or be integrated with a client computing device, such as the user device 610 of FIG. 6. For example, the content item collection provision module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the content item collection provision module 102. The data maintained by the data store 120 can include, for example, information relating to content item collections, content items, probabilities of users spending time on content items, machine learning models, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content item collection provision module 102 can be configured to communicate and/or operate with the data store 120. In some embodiments, the data store 120 can be a data store within a client computing device. In some embodiments, the data store 120 can be a data store of a server system in communication with the client computing device.

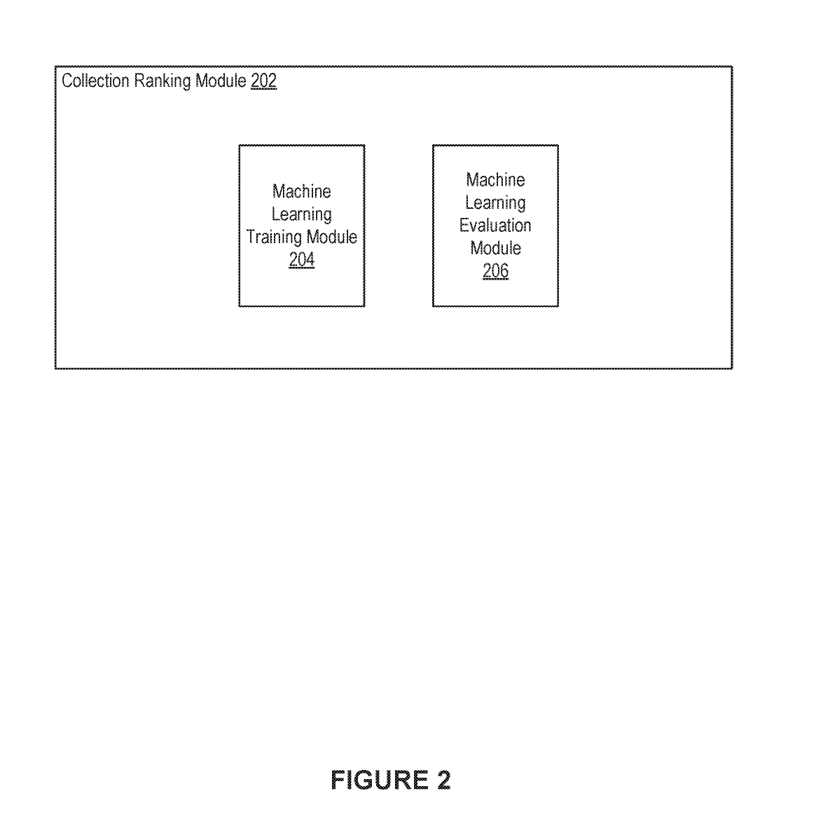

FIG. 2 illustrates an example collection ranking module 202 configured to rank content item collections, according to an embodiment of the present disclosure. In some embodiments, the collection ranking module 106 of FIG. 1 can be implemented with the example collection ranking module 202. As shown in the example of FIG. 2, the example collection ranking module 202 can include a machine learning training module 204 and a machine learning evaluation module 206.

The collection ranking module 202 can rank content item collections for a particular user. Content item collections can be ranked based on a probability of the user spending time on content items in a content item collection. A probability of the user spending time can be determined for each content item in a content item collection based on a machine learning model, as described below. The collection ranking module 202 can determine a score for a content item collection based on aggregated probabilities of the user spending time on content items in the content item collection. The collection ranking module 202 can rank content item collections based on respective scores. In some embodiments, a content item collection can be provided to the user if the score for the content item collection satisfies a threshold value. For example, one or more top content item collections can be provided to the user in a user interface.

The machine learning training module 204 can train a machine learning model to determine a probability of users spending time on content items. The machine learning training module 204 can train the machine learning model based on training data (e.g., labeled data) that includes content items of content item collections and an amount of time spent by users on content items. In some embodiments, the training data can indicate whether users spent time on content items, for example, instead of an amount of time spent by users on content items. The amount of time spent by users can be specified in an appropriate unit of time, such as second(s), minute(s), hour(s), etc. The training data can include various features. For example, features can be selected from content item attributes, user attributes, etc. Content item attributes can include any attributes associated with content items. Examples of content item attributes can include a type of media (e.g., an image, a video, an audio, text, etc.), a duration of a content item (e.g., time length of a video), a subject matter, one or more objects represented in a content item, a popularity of a content item (e.g., an extent to which users interact with a content item), etc. User attributes can include any attributes associated with users. User attributes can include attributes associated with authoring users and attributes associated with viewing users. An authoring user can refer to a user who creates a content item included in a content item collection. A viewing user can refer to a user who has access to a content item collection. Examples of user attributes can include a location (e.g., a country, state, county, city, etc.), an age, an age range, a gender, a language, a number of connections (e.g., friends or followers), interests (e.g., topics in which the user has expressed interest), a computing device, an operating system (OS), etc. In some embodiments, user attributes can also include attributes associated with connections between authoring users and viewing users. For example, a user can be a connection of another user (e.g., a friend or a follower), and a coefficient or weight can be associated with the connection. The coefficient can be indicative of a strength of the connection. In some embodiments, a connection between two users is two-way such that when the connection is established between a first user and a second user, the two users are connections of each other. In other embodiments, a connection between two users can be one-way such that a first user is a connection of a second user, but the second user is not a connection of the first user. In these embodiments, users can be subscribers or followers of other users. User attributes can further include attributes associated with interactions between authoring users and viewing users. Examples of interactions between authoring users and viewing users can include whether a viewing user liked a content item in an authoring user's feed or profile, whether a viewing user sent a direct message to an authoring user, etc. Weights associated with various features used to train the machine learning model can be determined. The machine learning training module 204 can retrain the machine learning model based on new or updated training data.

The machine learning evaluation module 206 can apply the trained machine learning model to determine a probability of a user spending time on a content item of a content item collection. For example, the trained machine learning model can be applied to feature data relating to the content item and the user to obtain the probability of the user spending time on the content item. The trained machine learning model can output a score indicative of a probability of the user spending time on the content item. In some instances, a probability of a user spending time on a content item can be denoted as P(time). In some embodiments, the score of a content item can be indicative of an estimated amount of time the user is likely to spend on the content item. For example, a probability of the user spending time on a content item can be expressed as an estimated amount of time the user is likely to spend on the content item. The estimated amount of time can be specified in an appropriate unit of time, such as second(s), minute(s), hour(s), etc. The scores for content items in a content item collection can be aggregated in order to determine a score for the content item collection. In some embodiments, a sum of the scores for the content items can be calculated as the score for the content item collection. In other embodiments, an average of the scores for the content items can be calculated as the score for the content item collection. Many variations are possible. In certain embodiments, the trained machine learning model can output both a score indicative of a probability of a user spending time on a content item and a score indicative of an estimated amount of time a user is likely to spend on a content item. One or more machine learning models discussed in connection with the content item collection provision module 102 and its components can be implemented separately or in combination, for example, as a single machine learning model, as multiple machine learning models, as one or more staged machine learning models, as one or more combined machine learning models, etc.

As explained above, the collection ranking module 202 can rank content item collections based on respective scores. In some embodiments, the score of a content item collection can be indicative of an aggregate probability of a user spending time on content items in the content item collection. In other embodiments, the score of a content item collection can be indicative of an aggregate amount of time a user is likely to spend on content items in the content item collection. In certain embodiments, the score of a content item collection can reflect both an aggregate probability of a user spending time on content items in the content item collection or an aggregate amount of time a user is likely to spend on content items in the content item collection.

In some embodiments, a probability of a user selecting a content item collection can be determined. In some instances, the probability can indicate a probability of a user selecting a representation of a content item collection or a representation of a first content item in a content item collection. For example, the probability of a user selecting a content item collection can be determined in addition to a probability of a user spending on content items in a content item collection. In some embodiments, a probability of a user selecting a content item collection can be denoted as P(select).

As stated above, a score of a content item collection can be based on aggregate probabilities of a user spending time on all the content items in the content item collection. However, in some embodiments, the score of a content item collection may not be based on a probability of a user spending time on a first content item in the content item collection. For example, if the representation of a first content item of a content item collection is provided to a user in a user interface, the content item collection can be ranked based on a probability of a user spending time on content items other than the first content item. In this example, the first content item may be ranked based on criteria other than a probability of a user spending time on the first content item, such as P(select). All examples herein are provided for illustrative purposes, and there can be many variations and other possibilities.

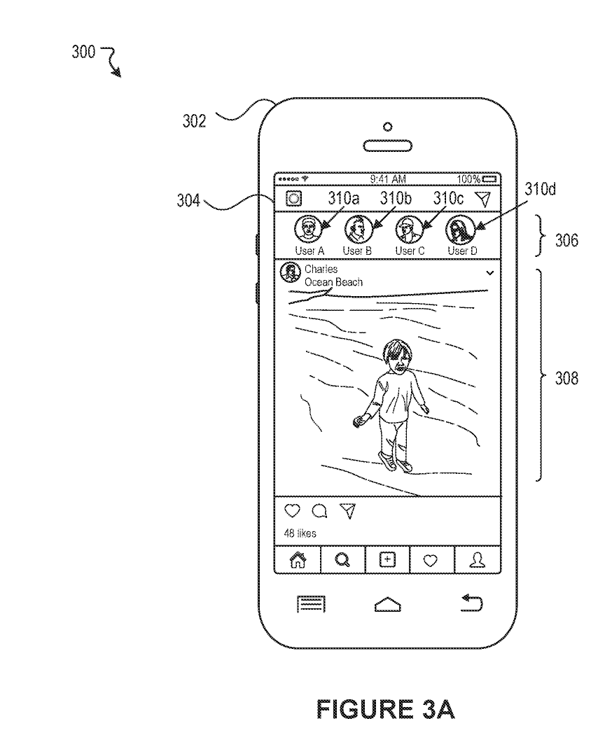

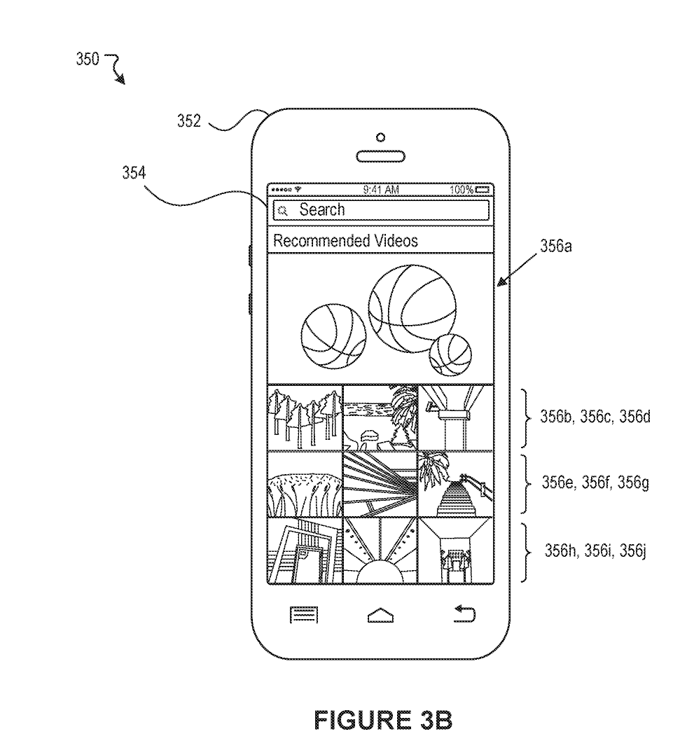

FIG. 3A illustrates an example scenario 300 for providing content item collections, according to an embodiment of the present disclosure. The example scenario 300 illustrates a computing device 302 displaying a user interface 304 associated with a social networking system. The user interface 304 includes a content item collection tray 306 of a user. The content item collection tray 306 can include representations 310 of one or more content item collections. In the example of FIG. 3A, the content item collection tray 306 includes representations 310a, 310b, 310c, 310d of corresponding content item collections. The representations 310a, 310b, 310c, 310d can appear in an order that reflects a ranking of respective content item collections. In the example of FIG. 3A, the content item collections 310 are user-based content item collections and are each associated with a particular user. For example, the content item collection 310a is associated with User A; the content item collection 310b is associated with User B; the content item collection 310c is associated with User C; and the content item collection 310d is associated with User D. The representations 310a, 310b, 310c, 310d are avatars of, respectively, User A, User B, User C, and User D. The ranking of content item collections can be performed by the content item collection provision module 102, as discussed herein. If the user selects a representation 310 of a content item collection, content items of the content item collection can be provided in a separate screen (or page) of the user interface 304. In some embodiments, content items of the content item collection can be provided in an immersive viewer. In certain embodiments, the content item collection tray 306 can be scrolled right in order to show representations of additional content item collections. The user interface 304 also includes a feed 308 of the user, which can include various content items. In some embodiments, content item collections can also be provided in the feed 308. All examples herein are provided for illustrative purposes, and there can be many variations and other possibilities.

FIG. 3B illustrates an example scenario 350 for providing content item collections, according to an embodiment of the present disclosure. The example scenario 350 illustrates a computing device 352 displaying a user interface 354 associated with a social networking system. The user interface 354 provides access to one or more content item collections. In the example of FIG. 3B, content items included in content item collections can be media content items, such as videos. For example, each content item collection can be a topic-based content item collection and can relate to a particular topic. A representation of a first video in each content item collection can be provided in the user interface 354. For example, the user interface 354 displays representations 356a-j of first videos for 10 content item collections. The representations 356a-j can appear in an order reflecting a ranking of respective content item collections in which the first videos are included. For example, the representations can appear in the order of ranking from top to bottom and left to right. For instance, the representation 356a can be associated with the first video of a highest ranked content item collection, the representation 356b can be associated with the first video of a second highest ranked content item collection, the representation 356c can be associated with the first video of a third highest ranked content item collection, and so forth. The ranking of content item collections can be performed by the content item collection provision module 102, as discussed herein. If a user selects a representation 356 of a first video of a content item collection, playback of the first video can start, for example, in a separate screen (or page) of the user interface 354. Other videos in the content item collection can be provided as related videos of the first video. In some embodiments, the other videos can automatically play after the playback of the first video completes.

In certain embodiments, the representations 356a-j can each be a representation of a media content item, such as a video. In these embodiments, a content item collection can correspond to a particular video associated with a representation 356. The content item collection corresponding to the particular video can include one or more content items related to the particular video. Some or all of the content items of the content item collection can be provided in response to selection of the representation 356. All examples herein are provided for illustrative purposes, and there can be many variations and other possibilities.

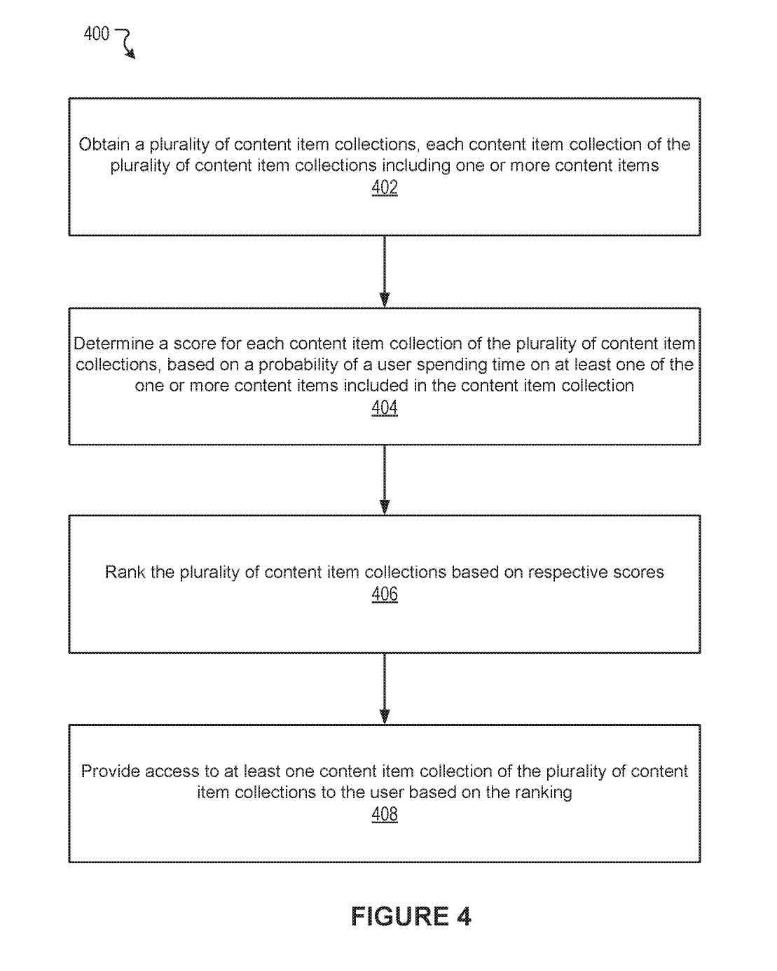

FIG. 4 illustrates an example first method 400 for providing content item collections, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a plurality of content item collections, each content item collection of the plurality of content item collections including one or more content items. At block 404, the example method 400 can determine a score for each content item collection of the plurality of content item collections, based on a probability of a user spending time on at least one of the one or more content items included in the content item collection. At block 406, the example method 400 can rank the plurality of content item collections based on respective scores. At block 408, the example method 400 can provide access to at least one content item collection of the plurality of content item collections to the user based on the ranking. Other suitable techniques that incorporate various features and embodiments of the present disclosure are possible.

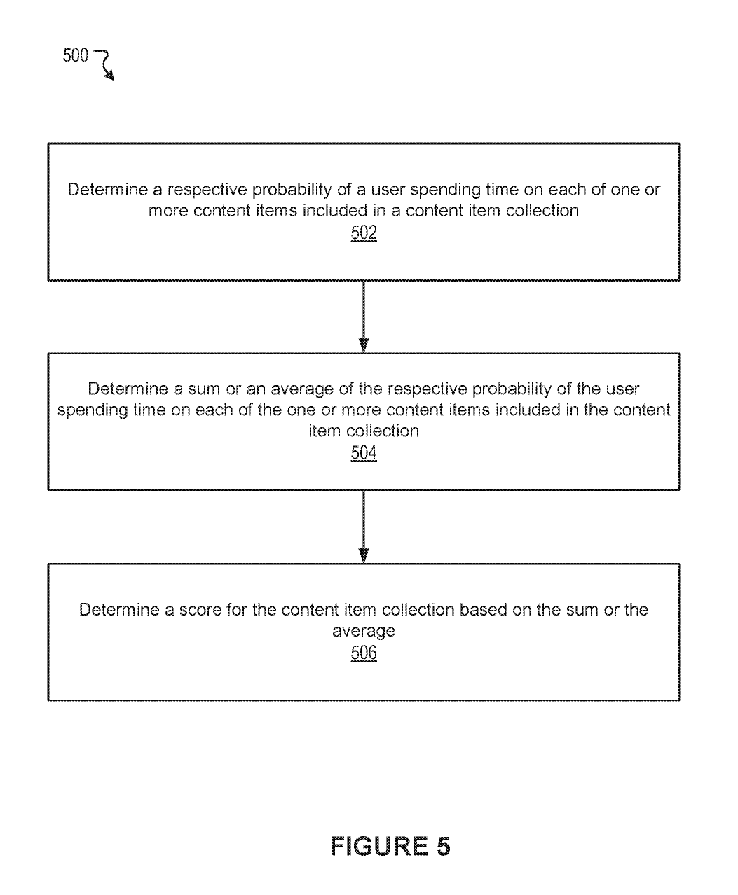

FIG. 5 illustrates an example second method 500 for providing content item collections, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can determine a respective probability of a user spending time on each of one or more content items included in a content item collection. The user can be similar to the user explained in connection with FIG. 4. The one or more content items can be similar to the one or more content items explained in connection with FIG. 4. The content item collection can be similar to the content item collection explained in connection with FIG. 4. At block 504, the example method 500 can determine a sum or an average of the respective probability of the user spending time on each of the one or more content items included in the content item collection. At block 506, the example method 500 can determine a score for the content item collection based on the sum or the average. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content item collection provision module 646. The content item collection provision module 646 can be implemented with the content item collection provision module 102, as discussed in more detail herein. In some embodiments, one or more functionalities of the content item collection provision module 646 can be implemented in the user device 610.

### Hardware Implementation

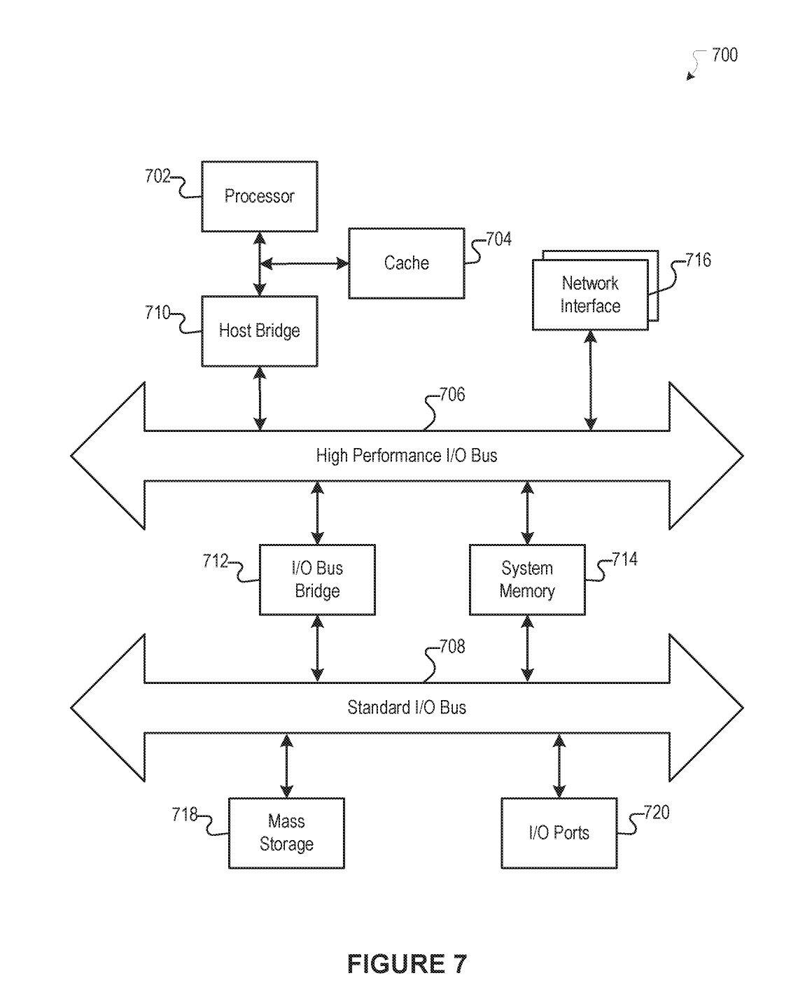

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the ×86-compatible processors manufactured by Intel Corporation of Santa Clara, Calif., and the ×86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a plurality of content item collections, each content item collection of the plurality of content item collections including one or more content items;
determining, by the computing system, a score for each content item collection of the plurality of content item collections, based on a probability of a user spending time on at least one of the one or more content items included in the content item collection;
ranking, by the computing system, the plurality of content item collections based on respective scores; and
providing, by the computing system, access to at least one content item collection of the plurality of content item collections to the user based on the ranking.

2. The computer-implemented method of claim 1, wherein the determining the score for each content item collection of the plurality of content item collections is based on a respective probability of the user spending time on each of the one or more content items included in the content item collection.

3. The computer-implemented method of claim 2, wherein the score for each content item collection of the plurality of content item collections includes one or more of: a sum of the respective probability of the user spending time on each of the one or more content items included in the content item collection, or an average of the respective probability of the user spending time on each of the one or more content items included in the content item collection.

4. The computer-implemented method of claim 1, wherein the providing access to at least one content item collection of the plurality of content item collections includes providing for display in a user interface at least one of: a representation of the at least one content item collection of the plurality of content item collections or a representation of a content item.

5. The computer-implemented method of claim 4, further comprising providing content items of the at least one content item collection of the plurality of content item collections in response to selection of at least one of: the representation of the at least one content item collection of the plurality of content item collections or the representation of the content item.

6. The computer-implemented method of claim 5, wherein the providing access to at least one content item collection of the plurality of content item collections includes providing the representation of the at least one content item collection of the plurality of content item collections for display in a content item collection tray.

7. The computer-implemented method of claim 5, wherein the one or more content items included in each content item collection of the plurality of content item collections are media content items, and the providing access to at least one content item collection of the plurality of content item collections includes providing a representation of a first content item for display in the user interface.

8. The computer-implemented method of claim 1, wherein the probability of the user spending time on the at least one of the one or more content items includes an estimated amount of time the user is likely to spend on the at least one of the one or more content items.

9. The computer-implemented method of claim 1, wherein the probability of the user spending time on the at least one of the one or more content items included in the content item collection is determined based on a machine learning model.

10. The computer-implemented method of claim 9, wherein the machine learning model is trained to predict a probability of a user spending time on a content item included in a content item collection based on features relating to one or more of: user attributes or content item attributes.

11. A system comprising:
at least one hardware processor; and
a memory storing instructions that, when executed by the at least one processor, cause the system to perform:
obtaining a plurality of content item collections, each content item collection of the plurality of content item collections including one or more content items;
determining a score for each content item collection of the plurality of content item collections, based on a probability of a user spending time on at least one of the one or more content items included in the content item collection;
ranking the plurality of content item collections based on respective scores; and
providing access to at least one content item collection of the plurality of content item collections to the user based on the ranking.

12. The system of claim 11, wherein the determining the score for each content item collection of the plurality of content item collections is based on a respective probability of the user spending time on each of the one or more content items included in the content item collection.

13. The system of claim 12, wherein the score for each content item collection of the plurality of content item collections includes one or more of: a sum of the respective probability of the user spending time on each of the one or more content items included in the content item collection, or an average of the respective probability of the user spending time on each of the one or more content items included in the content item collection.

14. The system of claim 11, wherein the providing access to at least one content item collection of the plurality of content item collections includes providing for display in a user interface at least one of: a representation of the at least one content item collection of the plurality of content item collections or a representation of a content item.

15. The system of claim 11, wherein the probability of the user spending time on the at least one of the one or more content items includes an estimated amount of time the user is likely to spend on the at least one of the one or more content items.

16. A non-transitory computer readable medium including instructions that, when executed by at least one hardware processor of a computing system, cause the computing system to perform a method comprising:
obtaining a plurality of content item collections, each content item collection of the plurality of content item collections including one or more content items;
determining a score for each content item collection of the plurality of content item collections, based on a probability of a user spending time on at least one of the one or more content items included in the content item collection;
ranking the plurality of content item collections based on respective scores; and
providing access to at least one content item collection of the plurality of content item collections to the user based on the ranking.

17. The non-transitory computer readable medium of claim 16, wherein the determining the score for each content item collection of the plurality of content item collections is based on a respective probability of the user spending time on each of the one or more content items included in the content item collection.

18. The non-transitory computer readable medium of claim 17, wherein the score for each content item collection of the plurality of content item collections includes one or more of: a sum of the respective probability of the user spending time on each of the one or more content items included in the content item collection, or an average of the respective probability of the user spending time on each of the one or more content items included in the content item collection.

19. The non-transitory computer readable medium of claim 16, wherein the providing access to at least one content item collection of the plurality of content item collections includes providing for display in a user interface at least one of: a representation of the at least one content item collection of the plurality of content item collections or a representation of a content item.

20. The non-transitory computer readable medium of claim 16, wherein the probability of the user spending time on the at least one of the one or more content items includes an estimated amount of time the user is likely to spend on the at least one of the one or more content items.
